(19) United States
(12) Patent Application Publication
(10) Pub. No.: US 2007/0280474 A1
(43) Pub. Date: Dec. 6, 2007

(54) Encryption Method

(76) Inventor: Karl E. Heinz, Bonn (DE)

Correspondence Address: GIFFORD, KRASS, SPRINKLE,ANDERSON & CITKOWSKI, P.C, PO BOX 7021, TROY, MI, 48007-7021, US

(21) Appl. No.: 11/736,028

(22) Filed: Apr. 17, 2007

Related U.S. Application Data
(60) Provisional application No. 60/792,696, filed on Apr. 18, 2006.

(51) Int. Cl. H04L 9/28

(52) U.S. Cl. 380/28

(57) ABSTRACT

An encryption method for encrypting byte represented text. A code key is first constructed from code text data by forming pair groups of data from the key text data. Each pair group includes a sequential text data byte from the key text data or an index to a pair group in the code key if the pair group already appears in the code key. The message text is then encrypted by searching the code key for the last pair group corresponding to sequential message data bytes and iteratively forming an encrypted message of sequential indexes of the last pair group or, if no pair group is found, from bytes of the message data.

### CROSS-REFERENCE TO RELATED APPLICATIONS

This application claims priority of U.S. Provisional Patent Application Ser. No. 60/792,696 filed Apr. 18, 2006, which is incorporated herein by reference.

### BACKGROUND OF THE INVENTION

I. Field of the Invention

The present invention relates to an encryption method for byte based text data.

II. Description of Related Art

There are many previously known encryption methods for encrypting text data for secure transmission of that data. These previously known encryption methods make use of either linguistic or mathematical schemes in constructing a code key.

The code key itself may be very complex but, given enough time, the code key can always be reconstructed. Once reconstructed, the encrypted text message may be decoded.

### SUMMARY OF THE PRESENT INVENTION

The present invention provides an encryption method which overcomes the previously known disadvantages of encryption methods by providing an encryption method utilizing an irregular key.

In brief, in the encryption method of the present invention, an arbitrarily selected key text is selected to form the code key. Preferably the key text exceeds four megabytes in length in order to ensure complete security of the subsequently transmitted encrypted message text.

In order to form the code key, the first and second bytes or text elements are assigned to a first pair group. Thereafter, sequential text data elements from the key text are retrieved and then examined to see if a pair group having the same elements already exists in the code key. If not, the key text elements form the next pair group and so on throughout the entire key text.

Conversely, if the pair group exists for the selected pair of key text, the index of the pair group in the code key together with the next following data element is again searched in the list of pair groups. If no pair group is found, the last found index together with the following data element form the entry of a new pair group. This entire process is then reiterated throughout the entire key text data.

Thereafter, to encode the message text, the pair groups or series of pair groups connected with indices of the group before for the pair group data in the message text are then replaced by the index of the last found pair group. If no pair group is found in the list of pair groups, the first data element, or the last found index, together with the following data element form the entry of a new pair group. Consequently, upon completion of the encoding process, the entire message text is replaced by indexes of pair groups of the code key text and individual data elements of the message text.

In order to decode the encrypted message, the above encoding process is simply reversed.

Since the code key is irregular, i.e. comprising not only indexes to various pair groups but indexes to other indexes in that same pair group, the encrypted message cannot be decoded except by those having the same key text data.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a flowchart illustrating the construction of the code key;

FIG. 2 is a flowchart illustrating the encryption method of message text using the code key; and

FIG. 3 is a flowchart illustrating decoding of the encrypted message using the code key.

### DETAILED DESCRIPTION OF A PREFERRED EMBODIMENT OF THE PRESENT INVENTION

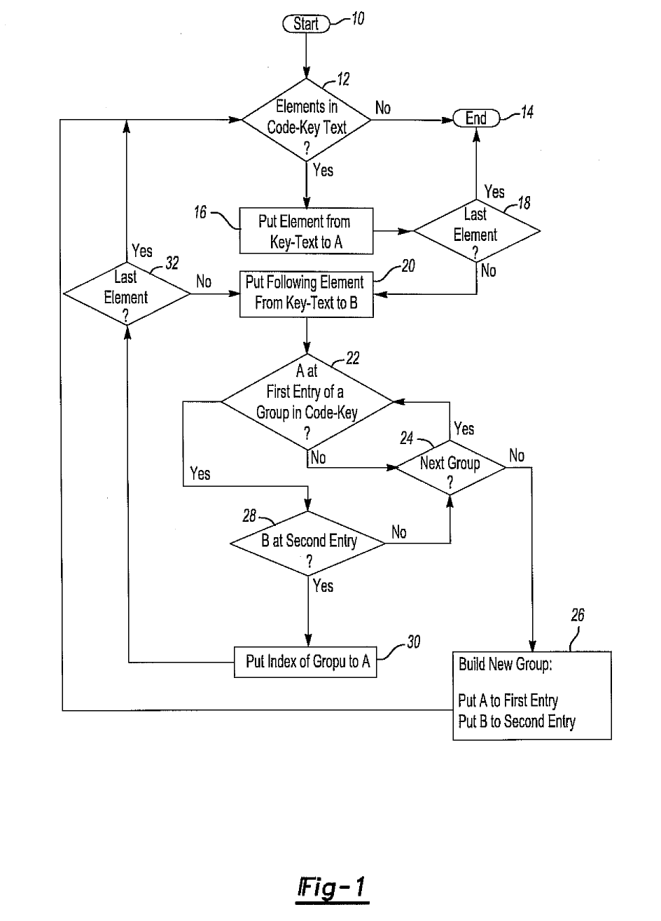

With reference first to FIG. 1, a flowchart illustrating the construction of the irregular code key of the encryption method of the present invention is shown. The code key construction begins at step 10 and then proceeds to step 12.

At step 12, the code key text is first examined to see if text elements remain in the code key text. The code key text comprises byte represented text data and is preferably four megabytes or more in size. If no text elements remain in the code key text, i.e. the end of the code key text has been reached, step 12 branches to step 14 which concludes the construction of the code key. Otherwise, step 12 proceeds to step 16.

At step 16, the first element from the code key text is placed in variable A and step 16 then proceeds to step 18. Step 18 then examines the code key text to determine if the text data in variable A represents the last text element of the code key text. If so, step 18 branches to step 14 which concludes the construction of the code key. Otherwise, step 18 branches to step 20.

At step 20, the following element in the code key text is placed in variable B and step 20 proceeds to step 22. The code key utilized to encrypt and decrypt the message consists of a plurality of pair groups that are constructed in a manner to be shortly described. At step 22, the first pair group is examined to see if the first element corresponds to the variable A. If not, step 22 branches to step 24 which determines whether or not more pair groups exist in the code key. If so, step 24 branches back to step 22 where the next pair group is examined to determine if the first entry corresponds to the variable A.

Consequently, it can be seen that steps 22 and 24 together iterate through the entire list of pair groups in the code key searching to see if the first element of any pair group corresponds to the variable A. If not, step 24 branches to step 26 after the entire code key has been examined where a new pair group for the code key is constructed by placing the variable A in the first entry and the variable B in the second entry. The new pair group is then appended to the bottom of the code key and step 26 branches back to step 12 where the above process is repeated.

Conversely, if the variable A appears as the first entry of a pair group in the code key, step 22 instead branches to step 28 where the second entry in the current pair group is examined to see if it corresponds to the variable B. If not, step 28 branches to step 24 where the next group is examined in the previously described fashion.

However, in the event that the variable A and the variable B correspond to the first and second entry of a pair group in the code key, step 28 instead branches to step 30 where the variable A is assigned the index of the identified group with indices beginning with the number 256. Step 30 then proceeds to step 32 which determines if the last element in the code key has been reached. If not, step 32 branches to step 20 where the above process is repeated until the last occurrence of the entries A and B in the code key are identified. Otherwise, step 32 proceeds to step 12 where the entire above-described process is repeated for the next elements in the code key text.

From the foregoing, it can be seen that the code key, upon conclusion of the processing of the code key text, comprises a plurality of pair groups containing individual key text byte data or an index to other pair groups in the code key. Furthermore, since the code key text comprises random text, the code key itself is irregular in construction in the manner in which it contains both data as well as indexes to other data.

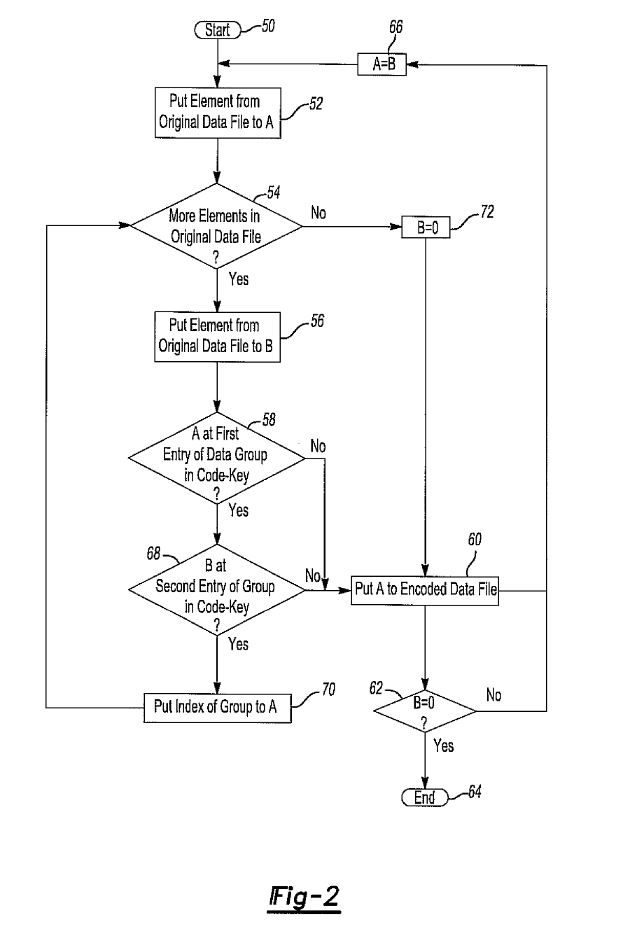

With reference now to FIG. 2, a flowchart illustrating the encoding method for encoding message text is shown. After the encoding method starts at step 50, step 50 then proceeds to step 52 where the first element of the message text is assigned to variable A. Step 52 then proceeds to step 54.

At step 54, the message text is examined to see if more text elements exist in the message text. If so, step 54 proceeds to step 56 where the next element of the message text is assigned to variable B. Step 56 then proceeds to step 58.

At step 58, the variable A is compared to the first entry in the pair groups of the code key. If not found, step 58 proceeds to step 60 where the variable A is appended to the encoded data file. Step 60 then proceeds to step 62 where B is examined to see if it equals zero, indicative of the end of file. If so, step 62 proceeds to step 64 and the encoding process is completed. Otherwise, step 62 branches to step 66 where the variable A is assigned the value of the variable B and step 66 then proceeds to step 54 where the above process is repeated.

Conversely, if the variable A corresponds to the first entry in any of the pair groups in the code key, step 58 instead branches to step 68 where the second entry of the pair group is compared to the variable B. If the second entry of the pair group does not equal the variable B, step 68 branches to step 60 where the encoding process proceeds in the fashion previously described. Otherwise, step 68 branches to step 70 where the index of the group is assigned to the variable A. Step 70 then branches back to step 54 where the above process is repeated.

Once step 54 reaches the end of the message text, step 54 branches to step 72 where the variable B is assigned to zero. Step 72 then proceeds to step 60 where the variable A is appended to the encoded message text and the encoding process proceeds through step 62 to step 64 thus completing the encoding process.

From the foregoing, it can be seen that the message text, once encoded utilizing the code key, comprises essentially random interspaced indexes to the various pair groups of the code key as well as individual elements of message text.

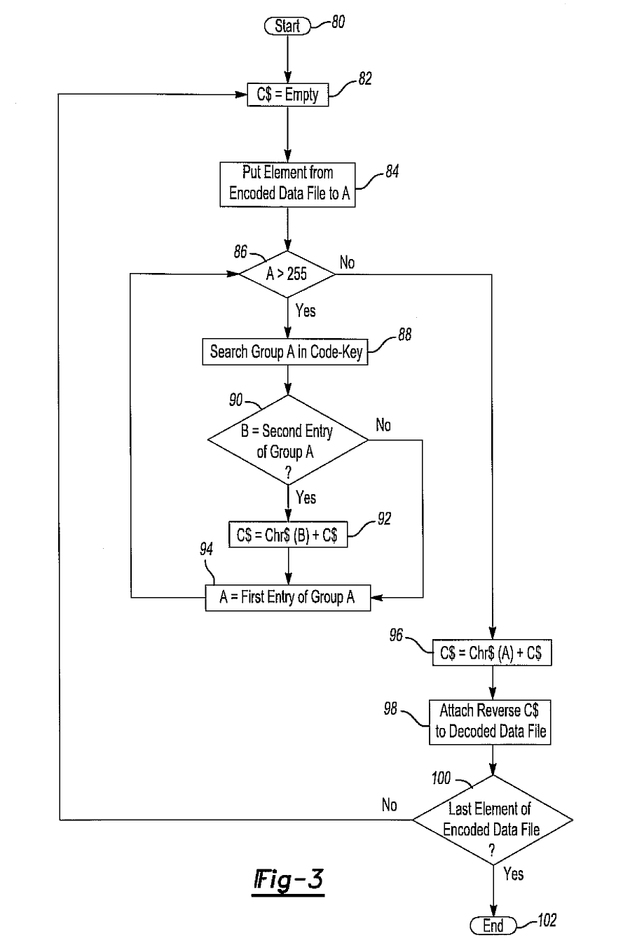

With reference now to FIG. 3, a flowchart illustrating the decoding process is shown. The decoding process, as described more fully below, utilizes the code key together with the code key text known only to the originator and receiver of the encoded message to encode the message text.

After initiation of the decoding process at step 80, step 80 proceeds to step 82 where the variable C$ is empty or set to a null string. Step 82 then proceeds to step 84.

At step 84, the next element of the coded message text is assigned to the variable A. Step 84 then proceeds to step 86.

At step 86, the variable A is compared to the number 255. A value of A greater than 255 is indicative that the variable A represents an index. Conversely, if the variable A is less than 255, the variable A represents text data.

Consequently, in the event that the variable A is greater than 255, indicative that the variable A represents an index, step 86 proceeds to step 88 where the group corresponding to the index of variable A is searched in the code key. Step 88 then proceeds to step 90.

At step 90, the second entry in the pair group identified by variable A is examined to determine if it corresponds to the variable B, the next entry in the encoded text data. If so, step 90 branches to step 92 where the text equivalent of variable B is added to the string C$. Step 92 then proceeds to step 94 where the variable A is assigned to the first entry of group A and step 94 then proceeds back to step 86 where the above process is repeated. Conversely, in the event that the variable B does not correspond to the second entry in the pair group at index identified by variable A, step 90 instead branches to step 94 without alteration of the variable C$.

Once text data is encountered in the encoded message text, step 86 instead branches to step 96 where the variable C$ is assigned to the string equivalent of the variable A added to the existing value of the variable C$. Step 96 then proceeds to step 98 where the reverse of the variable C$ is appended to a decoded data message file, i.e. the actual text of the encoded message. Step 98 then proceeds to step 100.

At step 100, the decoding process determines if the last element of the encoded data file has been reached. If so, step 100 branches to step 102 marketing the end of the decoding process. Instead, step 100 branches back to step 82 where the above process is repeated.

Consequently, from the foregoing it can be seen that the decoding process by tracing the indexes of the code key back to the original key text data, the entire encoded message may be decoded from the code key and the code key text.

Although ASCII may be used to encode the text data, other non-ASCII codes may also be used. Likewise, a pixel list, i.e. color and intensity, may be used to encode pictures.

From the foregoing, it can be seen that the present invention provides a novel encryption method which effectively encodes byte represented text data by utilizing a random key code which is constructed from random key code text. Consequently, the resulting message cannot be decoded except by someone having access to the key code text.

Having described my invention, many modifications thereto will become apparent to those skilled in the art to which it pertains without deviation from the spirit of the invention as defined by the scope of the appended claims.

I claim:

1. An encryption method for encrypting text comprising the steps of:
constructing a code key from byte represented key text data by forming pair groups of data from the key text data, each pair group comprising sequential text data bytes from the key text data or an index to a pair group in the code key if said pair group already appears in the code key,
encrypting a byte represented message data by searching said code key for the last pair group corresponding to sequential message data bytes and iteratively forming an encrypted message of sequential indexes of said last pair group or, if no pair group is found, from bytes of said message data.

2. The invention as defined in claim 1 and further comprising the step of decoding the encrypted message, said decoding step comprising the steps of:
A) reading sequential bytes of said encrypted message,
B) searching pair groups in said code key by index until a text element is identified,
C) appending the identified text element to a decoded message string,
D) reiterating steps A-C until the end of the encrypted message.

3. The invention as defined in claim 1 wherein said key text data comprises ASCII encoded text data.

4. The invention as defined in claim 1 wherein said key text data comprises non-ASCII encoded text data.

5. The invention as defined in claim 1 wherein said message data comprises at least four megabytes of text data.

6. The invention as defined in claim 1 wherein said key text data comprises a pixel list of color and intensity.
